(19) United States
(12) Patent Application Publication
(10) Pub. No.: US 2025/0284720 A1
(43) Pub. Date: Sep. 11, 2025

(54) Distributed Hybrid Search for Language-Agnostic, Real-Time Information Retrieval

(71) Applicant: Dell Products L.P., Round Rock, TX (US)

(72) Inventors: Daniel Felbah, Toledo, OH (US); Ashutosh Singh, Austin, TX (US); Ushnesha Daripa, Chandil (IN)

(73) Assignee: Dell Products L.P., Round Rock, TX (US)

(21) Appl. No.: 18/601,717

(22) Filed: Mar. 11, 2024

(51) Int. Cl. G06F 16/33; G06F 16/338; G06F 16/35; G06F 16/93

(52) U.S. Cl. CPC G06F 16/334; G06F 16/338; G06F 16/353; G06F 16/93; G06N 3/02

(57) ABSTRACT

A computer-implemented method for performing searches in a document database is disclosed. The method comprises automatically detecting a line of business associated with a user, receiving a text query from the user, and generating a query embedding from the text query. The method further comprises scoring entries in a reverse index using a hybrid scoring function. The reverse index comprises titles, title embeddings, sentences, sentence embeddings, and entity tags corresponding to documents in the document database. The hybrid scoring function is used to generate a score based both on a keyword match score between the text query and the reverse index and on a cosine similarity score calculated from embeddings in the text query and in the reverse index. The method also comprises ranking scores for sentences in the document database, and displaying a sentence associated with a top score to the user.

### BACKGROUND

Business and other large enterprises typically have numerous text-data sources that can be accessed in the context of information retrieval and extraction for a variety of use cases. The text-data sources include, for example, knowledge base articles, product manuals, product support emails, helpdesk call logs, and community website posts. Video and audio files can also be processed as text data (e.g., using an audio transcription or video description) and may serve as additional sources of text data. These text-data sources may be used for services such as question answering, technical support, website chatbots, and email and content generation. Text data may also be used to respond to requests for proposal or other business queries. Legacy Information Retrieval (IR) systems depend on searching for keywords within a text corpus (i.e., a data set consisting of digitalized resources that may be either annotated or unannotated) to identify pertinent sections of documents.

### SUMMARY

Embodiments are directed to a novel Information Retrieval (IR) system that combines legacy search methodologies with deep learning based IR techniques to create a highly accurate and scalable IR system.

In one embodiments, a computer-implemented method is used to perform searches in a document database. The method comprises automatically detecting a line of business associated with a user, receiving a text query from the user, and generating a query embedding from the text query. The method further comprises scoring entries in a reverse index using a hybrid scoring function. The reverse index comprises titles, title embeddings, sentences, sentence embeddings, and entity tags corresponding to documents in the document database. The hybrid scoring function is used to generate a score based both on a keyword match score between the text query and the reverse index and on a cosine similarity score calculated from embeddings in the text query and in the reverse index. The method also comprises ranking scores for sentences in the document database, and displaying a sentence associated with a top score to the user.

The hybrid scoring function has the general form:

$$Hybrid Score = ( 1 + Keyword Match Score ) \times ( 1 + Cosine Similarity Score ) . \qquad ( Eq . 1 )$$

A customized version of the hybrid scoring function has the form:

$$Hybrid Score = ( 1 + k 1 ) \times ( 1 + k 2 ) \times ( 1 + k 3 ) \times ( 1 + s 1 ) \times ( 1 + s 2 ) , \qquad ( Eq . 2 )$$

wherein
k1 represents a score for a first keyword matching between the text query and the titles;
k2 represents a score for a second keyword matching between the text query and the sentences;
k3 represents a score for a third keyword matching between the user line of business and the entity tags;
s1 denotes a first search score based on embeddings, which measures cosine similarity between the query embedding and the title embeddings; and
s2 denotes a second search score based on embeddings, which measures cosine similarity between the query embedding and the sentence embeddings.

The user line of business may be detected based upon a device used by the user to send the text query. The user line of business may also be determined based on a product or device associated with a user account. The line of business and the entity tags may comprise one or more of: product codes or names, product categories, product types, error codes, lines of business, model numbers, serial numbers, and entity brand names.

The method may further comprise dividing the reverse index into shards, storing groups of the shards at two or more locations, and scoring entries in multiple reverse index shards simultaneously. The method may include creating replicas of the shards, and storing groups of the replicas at the two or more locations.

In addition to providing the text of a top scoring sentence to the user, The method may also provide the user with a link to a source document for the sentence associated with the top score.

### BRIEF DESCRIPTION OF THE DRAWINGS

Having thus described the invention in general terms, reference will now be made to the accompanying drawings, which are not necessarily drawn to scale, and wherein:

FIG. 1 illustrates keyword similarity searching on two documents where each document comprises a number sentences.

FIG. 2 illustrates embedding similarity searching on two documents where each document comprises a number sentences, and each sentence can be represented by an embedding.

FIG. 3 is a visual representation of the hybrid search algorithm concept disclosed herein.

FIG. 4 illustrates a cluster with nodes containing shards and their replicas for portions of an entity's knowledge base data set.

FIG. 5 is a flowchart illustrating how the hybrid search algorithm works for an entity's information retrieval system.

FIG. 6 is a high level block diagram illustrating components for implementing an information retrieval system and for performing the actions in the flowchart of FIG. 5.

FIG. 7 illustrates a block diagram of an example information handling system for executing operations associated with an information retrieval system in accordance with embodiments of the present disclosure.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The embodiments disclosed herein provide a highly accurate information retrieval system with semantic capabilities that can be adapted for specific enterprise use cases. In example embodiments, an Information Retrieval (IR) system combines legacy search methodologies with newer, deep-learning-based information retrieval techniques to create a highly accurate and scalable information retrieval system.

In the computing and information science context, information retrieval is the process of obtaining information system resources that are relevant to an information need from a collection of such resources. Searches may be based on full-text or content-based indexing. Information retrieval is the science of searching for information in a document, searching for the documents themselves, and searching for metadata that describes data from databases of texts, images, or sounds. Generally, information retrieval in this disclosure is used in the context of text documents; however, that context can be extended to information retrieval from audio and video data sources through text transcription or text descriptions of such sources. Information retrieval from image files may also be included where there is metadata or text describing image contents or where an Optical Character Recognition (OCR) process or other image processing application is applied to a digital image to recognize text or objects within a digital image.

For the examples used in this disclosure, information retrieval is generally separated into two methods: keyword similarity search and embedding similarity search. It will be understood that the claimed invention is not limited to these methods and that in other embodiments other information retrieval methods may be used.

In the keyword similarity search method, a bag-of-words ranking function is used by a search engine to estimate the relevance of various documents to a given search query. The retrieval function ranks a set of documents based on the query terms that appear in each document. This ranking does not consider the query terms' proximity within the documents. Keyword similarity searching may use various scoring functions with slightly different components and parameters. Okapi BM25 is one of the most prominent instantiations of the ranking function and is a Term Frequency-Inverse Document Frequency (TF-IDF) retrieval function. The Okapi BM25 scoring function is defined as:

$$score ( Q , D ) = {\sum }_{i = 0}^{n} \frac{( k + 1 ) * f ( q , D )}{f ( q , D ) + k * ( 1 - b + b * ( \frac{\vert D \vert}{avgdl} ) )} * IDF ( q ) \qquad ( Eq . 3 )$$

Such that,
Q=query,
D=document,
f(q,D)=term frequency of q in D,
   |D|=length of D,
avgdl=average document length,
IDF(q)=inverse document frequency of q, and
k and b=free parameters, typically k=1.2 and b=0.75.

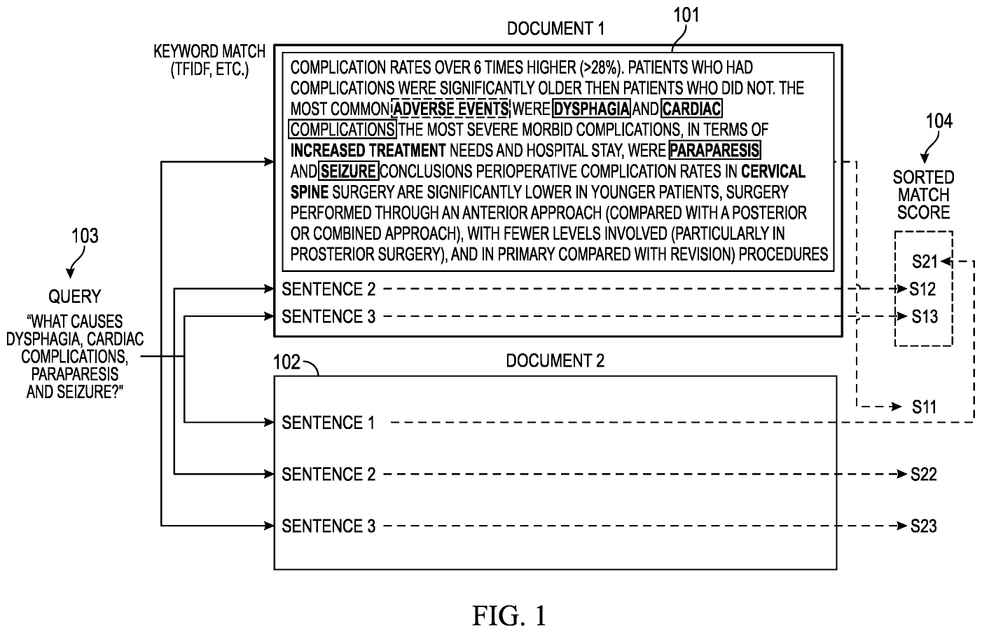

FIG. 1 illustrates keyword similarity searching on two documents 101, 102. Each document comprises a number sentences. A query 103 comprises a number of keywords, such as “dysphagia,” “cardiac complications,” “paraparesis,” and “seizure.” Each sentence is analyzed individually for the keywords. A match score is generated for each sentence. For example, match score S11 corresponds to the occurrence of keywords in document 1, sentence 1. The match scores may be ranked and sorted 104 for a plurality of documents 101, 102. In the example illustrated in FIG. 1, the best match to the query 103 is S21 or the first sentence of document two 102. In an information retrieval system using keyword similarity searching, that sentence could be returned to user in response to query 103.

In the embedding similarity search method, a word/sentence/document embedding is a representation of a word/sentence/document. The embedding is used in text analysis. Typically, the representation is a real-valued vector that encodes the meaning of the word/sentence/document in such a way that words/sentence/documents that are closer in the vector space are expected to be similar in meaning. Embeddings can be obtained using language modeling and feature learning techniques where words or phrases from the vocabulary are mapped to vectors of real numbers. Methods to generate this mapping include neural networks, dimensionality reduction on the word co-occurrence matrix, probabilistic models, explainable knowledge base method, and explicit representation in terms of the context in which words appear.

In the scope of this disclosure, the word “embeddings” (or “sentence embedding”) refers to the numerical representation of natural language sentences that are generated using neural networks. The numerical representation of natural language sentences in vector space allows for the use of vector space techniques to exploit favorable properties for modelling for a text corpus. One favorable property is the ability to estimate the similarity between two vectors. The vector space is generated in the context of a semantic relationship between words and sentences. The similarity between vectors is an estimate of the semantic similarity between the original sentences being represented by the respective vectors. If the vector space is generated for multiple languages, the similarity estimate is language agnostic and can operate between languages.

Multiple metrics may be used for calculating vector similarities. These include but are not limited to:
Cosine Similarity,
Euclidean Distance,
Manhattan Distance,
Jaccard Similarity, and
Pearson Correlation Coefficient.

In the examples discussed herein the word “similarity” refers to Cosine Similarity, which is defined mathematically as:

$$cosine similarity = \frac{A * B}{‖ A ‖ * ‖ B ‖} \qquad ( Eq . 4 )$$

where A and B are vectors in the same real vector space. The metric defined by the equation (4) above is low bounded by −1 and high bounded by +1. Higher values of the metric represent higher levels of similarity between vectors.

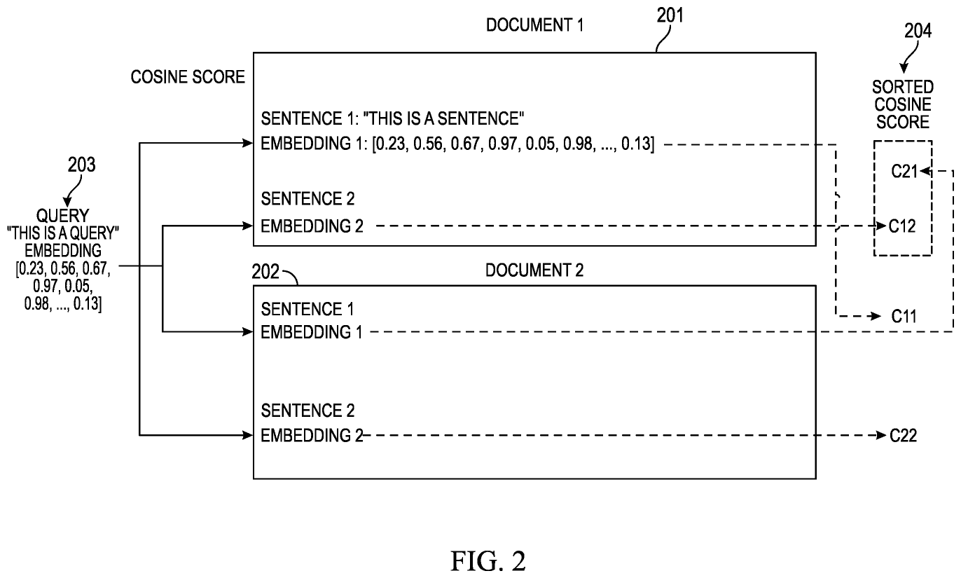

FIG. 2 illustrates embedding similarity searching on two documents 201, 202. Each document comprises a number sentences, and each sentence can be represented by an embedding. The embedding is a representation of the semantic meaning of a piece of text. Each embedding is a vector of floating-point numbers. A text query 203 also has an embedding. A cosine score is generated for each sentence to compute the similarity between sentences and the query. For example, cosine score C11 corresponds to the cosine score for document 1, sentence 1. The cosine scores may be ranked and sorted 204 for a plurality of documents. In the example illustrated in FIG. 1, the best match to the query 203 is S21 or the first sentence of document two 202. In an information retrieval system using keyword similarity searching, that sentence could be returned to user in response to query 203.

The keyword similarity search and embedding similarity search methods are effective for small search spaces; however, the accuracy begins to decrease with as the search space increases in size. Optimization techniques may be used to scale the search methods to larger search spaces. Optimization techniques include, for example, multi-stage search, metadata optimization, and ranking. It will be understood that this is not a comprehensive list and that other search optimization techniques may also be used.

A multi-stage search may be used to reduce the search space to compensate for reduced accuracy over large spaces. The search space may be reduced over multiple stages by performing preliminary searches. An example of this type of search is commonly seen in answer retrieval, where a two-stage search process is used. The first stage search is focused on finding a subset of relevant documents by searching on fields containing a high-level description of the documents, such as the article title, an article summary, etc. The second stage is focused on searching the combined text of the relevant articles to find answers to the question under consideration.

Metadata is another method commonly used to reduce search space. The metadata may be related to the data, the entities in the data, or the end user. The search space is reduced to relevant documents based on the metadata, and then searched for results. An example of this method is product searching on e-commerce websites. A search query could return different results based on geographic location, user persona, etc.

Ranking is used to prioritize search results based on their past utility. This optimization method, instead of trying to reduce search space, boosts search results that have been previously relevant for similar queries. This method also requires the collection of direct or indirect feedback to assess the utility of search results. Ranking and metadata are also used in conjunction to boost search results based on their past utility in relation to the associated metadata.

The embodiments of an information retrieval system with semantic capabilities as disclosed herein are directed to a distributed hybrid search for language-agnostic, real-time information retrieval from text documents. Upon receiving a query, they system matches the query to the correct documents and recommends relevant text from within the documents. The system allows for language agnostic searches and provides semantic and contextual capabilities and ranking in near real time using current information awareness.

The following common terms and nomenclature are used to describe the systems and methods described herein:

Knowledge Base (KB): An exhaustive compendium of an entity's technical support documentation including, but not limited to, user manuals and troubleshooting guidelines, devised to address customer inquiries and to furnish in-depth information on the entity's products and services.

Support Website: An entity's website for facilitating customer interactions, granting access to support resources, such as a virtual assistant, support library, contact information, etc.

Virtual Assistant (VA): an application on an entity's website, which enables chat based support. The Virtual Assistant is geared towards enabling self-diagnosis by the user before eventually transferring the chat to a support agent.

Natural Language Processing (NLP): An interdisciplinary subfield of linguistics, computer science, and artificial intelligence concerned with the interactions between computers and human language, and how to program computers to process and analyze large amounts of natural language data. The goal of NLP is a computer capable of “understanding” the contents of documents, including the contextual nuances of the language within them.

Sentence Embeddings: Mathematical representation of a natural language sentence as a real vector in a vector space of predefined dimensions.

Distributed Inverted Index Database: An inverted index (also referred to as a postings list, postings file, or inverted file) is a database index storing a mapping from content, such as words or numbers, to its locations in a table, or in a document or a set of documents (named in contrast to a forward index, which maps from documents to content). The purpose of an inverted index is to allow fast, full-text searches at the cost of increased processing when a document is added to the database. The inverted file may be the database file itself rather than its index. It is the most popular data structure used in document retrieval systems and is used on a large scale for example in search engines. In a distributed architecture, the data in this database would be broken down into chunks to enable parallel retrieval to further improve speed and scalability over large data sets.

The following criteria are design requirements for an example information retrieval use case for an entity, such as a business supporting many product lines across a large distributed customer base. These criteria are necessary for scaling a prospective information retrieval solution across various use-cases and data types. The criteria include:
semantics and contextual understanding,
question answering,
language interoperability,
generalization to entity-specific words and new words,
overcoming cold-start problem,
real-time performance, and
performance over alpha-numeric and one-word queries.

While many of these criteria are fulfilled by at least one of the two methodologies discussed above, obtaining a solution that fulfills the complete set requires a hybrid solution obtained by combining keyword similarity searching with embedding similarity searching and using customized metadata associated with the data.

Semantic and Contextual Modeling: to retrieve relevant information from a document corpus, the semantics and context that emerge from the relative positioning of words in sentences and sentences in paragraphs needs to be modeled by the algorithm under consideration. Keyword similarity search algorithms, in general, are less effective in capturing the semantics and context arising from the ordering of words and sentences. On the other hand, embedding similarity search algorithms are designed with a focus on modelling the sequences of words and/or sentences by representing the words/sentences in a vector space. A word/sentence embedding in a vector space is the representation of the inherent meaning associated with the word/sentence under consideration and is derived using the relative position of them in the sequence.

Question Answering (QA) is a computer science discipline within the fields of information retrieval and Natural Language Processing (NLP) that is concerned with building systems that automatically answer questions that are posed by humans in a natural language. A question-answering implementation, such as a computer program, may construct its answers by querying a structured database of knowledge or information (e.g., a knowledge base). More commonly, question-answering systems can pull answers from an unstructured collection of natural language documents. Historically, keyword similarity search and embedding similarity search have both been used in question-answering systems. Embedding similarity search algorithms, especially the ones utilizing sentence embeddings created in context of the paragraph or the sentences, outperform most methods for most of the data sets and use cases.

Language Interoperability is important for entities that publish information in multiple languages. The knowledge base forms a mutually exclusive set of information. Moreover, global operations lead to publication of knowledge base documents in mixed languages. Language interoperability, in the scope of this disclosure, refers to the goal of retrieving the most relevant information irrespective of the language(s) of the incoming query or the knowledge base. Design constraints on language interoperability call for avoiding recurring calls to translation APIs. The reasoning for this constraint is to eliminate the latencies and the costs associated with such API calls. Embedding similarity search algorithms, due to their ability to understand semantics and context, can enable language interoperability given that the embeddings were created using a multilingual data set. Such an embedding would preserve meaning of sentence in the same embedding vector space, irrespective of the language(s).

Generalization to New Words. Entities typically publish new knowledge base documents and update old ones regularly. The number of updates and new publications generated every week can be in the thousands. These documents contain information related to new models, error codes, components, technologies, and terminologies. The design constraint to generalize to these new words arises from the observation of these new terms being represented in a majority of input queries and request for information from most of the information retrieval use cases. Keyword similarity search algorithms generalize well over new words and terms, because these algorithms search for the words directly. Embedding similarity search algorithms depend on their training data to make accurate representation of sentences in the embedding vector space. Sentences with words/terms that are not a part of the training data have weak representation in the embedding vector space, hence embedding similarity search algorithms do not generalize well over documents with new words/terms.

The Cold Start Problem is relevant for keyword search methods. Utilizing keyword frequency to match documents results in little semantic understanding. For large search spaces, multiple results are returned with similar match scores but different semantics. To filter more relevant results out of the returned documents, a ranking mechanism is used. The ranking mechanism utilizes metadata about the end user, the query, historical feedback for similar queries, and the like to rank documents for similar meta data and incoming queries. This enables the search methods to return more relevant documents. The ranking mechanisms cause the Cold Start Problem. A new entry into the document databases lacks the metadata used for ranking and, therefore, would be ranked lower. It takes time before metadata is collected for the new document and the new document starts getting more accurate ranking. The ranking system also leads to selection bias wherein highly ranked documents are returned more often and in-turn get ranked even more highly, while documents that are ranked lower are returned less leading to further lower ranking. Ranking is at least partially utilized to overcome a lack of semantic understanding of the keyword search methods. Vector search methodologies can reduce dependence on such a ranking system, although some filtering is still required to return more relevant documents.

The Real-time Performance design constraint is an engineering problem. For user-support use cases, latency requirements for returning results are stringent. The results need to be returned in real time and long return time leads to a suboptimal end user experience. Search latency is not directly dependent on the search methodology and the correlation is found to be weak at best. Latency is dependent on a variety of factors including, but not limited to:
search space (i.e., the number of documents),
database and production database architecture,
algorithm (methodology),
API design,
network,
query, and
load balancer.
   The above-listed factors have biggest impact on latency overall but, given all other factors held constant, keyword similarity search is significantly faster than embedding similarity search.

Alpha-Numeric and One-Word Queries. Around fifty percent of input queries as received by an entity's virtual assistant are expected to be one-word queries. Many of these are alphanumeric labels, such as error codes, model numbers, or unique identifiers for drivers, software, and peripherals. Both the search methodologies can generalize to such queries. Embedding similarity search does not generalize to alpha-numeric labels unless they are a part of the training data. New alpha-numeric labels would require comprehensive re-training of the embeddings to generalize to them. Keyword similarity search algorithms can generalize to new words without needing any retraining and, therefore, have an advantage over embedding similarity search.

The above-specified design requirements can be achieved using a hybrid search algorithm that combines both keyword similarity search and embedding similarity search techniques. This algorithm is deployed using a reverse-indexed distributed database.

A hybrid search algorithm as disclosed herein integrates the strengths of both keyword similarity search and embedding similarity search to overcome their individual limitations, which are complimentary with respect to the above-listed design criteria.

A hybrid search score is determined by a general formula:

$$Hybrid Score = ( 1 + Keyword Match Score ) \times ( 1 + Cosine Similarity Score ) \qquad ( Eq . 1 )$$

This general formula allows for the integration of multiple keyword and semantic signals, thereby enabling a more nuanced and contextually rich result set.

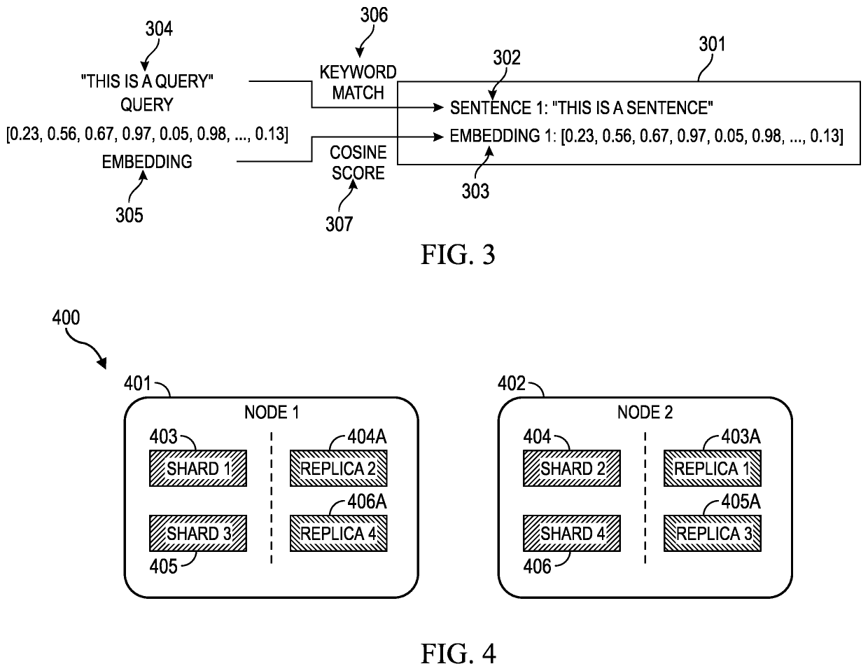

FIG. 3 is a visual representation of the hybrid search algorithm concept. A document 301 comprises one or more sentences 302, each having an associated embedding 303. A query 304, such as a question or a request from a user, also has an associated embedding 305. Keywords can be extracted from the query 304 and used in a keyword similarity search against sentence 302 to generate a keyword match score 306. Similarly, the query embedding 305 can be used in an embedding similarity search against sentence embedding 303 to generate a cosine similarity score 307. The values of the keyword match score 306 and the cosine similarity score 307 provide inputs to equation (1) above to generate a hybrid score for sentence 302 of document 301. The same process can be repeated across the other sentences in document 301 and across other documents in the entity's data set.

In an example use case, a Keyword Match Score is calculated based on a user query and different fields within articles that form the entity's Knowledge Base (KB). These fields may be, for example, article titles and sentences. The Cosine Similarity Score is determined between query embeddings and embeddings derived from the Knowledge Base (KB) article titles and sentences.

The general hybrid scoring formula can be modified to meet an entity's requirements and to accommodate various use-case factors, such as handling queries related to the entity's products. The general hybrid score formular (i.e., Eq. 3 above) can be adjusted in the following manner:

$$hybrid score = ( 1 + {k}_{1} ) \times ( 1 + {k}_{2} ) \times ( 1 + {k}_{3} ) \times ( 1 + {s}_{1} ) \times ( 1 + {s}_{2} ) \qquad ( Eq . 2 )$$

where:
k₁ represents the score for the first keyword matching between the query and article title,
k₂ represents the score for the second keyword matching between the query and article sentence,
k₃ represents the score for the third keyword matching between the query and an affected product list,
s₁ denotes the first search score based on embeddings, which measures cosine similarity between query embeddings and article title embeddings, and
s₂ denotes the second search score based on embeddings, which measures cosine similarity between query embeddings and sentence embeddings.

By incorporating this modified formula into the hybrid search algorithm, the algorithm achieves a balanced, context-aware ranking of search results, which leads to an optimized search experience for users.

By carefully selecting how the system deployment architecture, an entity can provide a scalable search experience. Considerations for deployment architecture include Inverted Index Databases, Sharding, and Replication and how to utilize these to achieve near real time search latencies.

An Inverted Index Database enables effective searching across databases. An inverted index allows the system to quickly find documents that contain a term or set of terms. Unlike a standard index that stores a list of references for each document, an inverted index stores references (such as document IDs) for each term. This approach greatly enhances search efficiency and significantly reduces query lookup times by accessing a list of documents based on the query terms. As a result, real-time search capabilities are made possible.

Sharding helps to address challenges due to the size of the data set. By dividing the data set into manageable pieces or “shards, the database can be distributed across multiple servers. Each shard operates independently, allowing parallel processing of queries. For example, when a data set is divided into ten parts, a query can potentially be run up to ten times faster because each part or shard processes its portion of the data simultaneously.

Replication can be implemented to ensure fault tolerance and faster data retrieval. With replication, one or more copies of each shard is stored on different servers. In case a server fails, the system can immediately switch to a replicated part thereby ensuring uninterrupted service. Also, replication enables further distribution of the search load across replicas which provides even faster retrieval speeds.

FIG. 4 illustrates a cluster 400 with nodes 401, 402 containing shards and their replicas. A data set is divided into four shards 403-406. Node 401 stores the primary copy of the first and third shards 403, 405, while node 402 stores the primary copy of the second and fourth shards 404, 406. Node 401 also stores replicas of the second and fourth shards 404a, 406a. Node 402 stores replicas of the first and third shards 403a, 405a. With this architecture, a query can be processed simultaneously against shards ⅓ and shards 2/4, which should effectively cut the processing time in half. Also, this architecture protects the system from outages. If node 402 is down, such as due to a server or communication failure, then shards 404, 406 will be unavailable. In this situation, node 401 will be able to search all four parts of the data set using the replica copies 404a, 406a of shards 404, 406.

### 6.2.4 Multi-Layered Scoring Components in Indexing

As referenced in equation (2) above, the hybrid scoring algorithm uses a composite scoring function with five individual scores. To avoid computing the individual scores in sequence, an index structure can be used to compute the individual score in parallel, thereby reducing latency by a factor of five.

A deployment strategy is used to configure the system architecture in a way that determines the optimal number of shards and nodes. Assuming a replication number set to two, the initial number of shards is selected with an empirical guess. Then, the following strategy is used to arrive at optimal numbers.
1. Breakdown the data set into individual sentences, while preserving relationships through metadata. For each individual sentence, an index is created based on the predetermined index structure;
2. Ingest the data in the database and estimate average response latency by posting queries of varying lengths. These queries may be derived from distribution of queries as observed in the field;
3. Change the number of shards to find the number of shards that lead to minimum response latency; and
4. If the minimum latency is greater than 0.1 seconds, add an additional database node and repeat steps 1 to 3.
   As the amount of data increases in the production system, the optimization strategy discussed above is repeated at regular intervals to ensure retrieval latency is less than or equal to 0.1 second.

The system is expected to be able to maintain retrieval latencies lower than 0.1 second, irrespective of the size of the data, by
1. Using an inverted index database and optimizing for number of shards and nodes; and
2. Estimating individual scores of the composite scoring function in parallel,

In comparison to existing in-memory solutions, such as LangChain and LlamaIndex the architecture described herein is specifically designed for scalability and depth. While in-memory databases are fast, such databases often struggle with the size and complexity of large data sets. The approach disclosed herein provides both high speed and high accuracy.

Table 1 below illustrates how each search methodology—Keyword Search, Embedding (Semantic) Search, and the proposed Hybrid Search—addresses the design criteria listed above.

TABLE 1

| | KEYWORD | EMBEDDING | HYBRID |
|---|---|---|---|
| CRITERIA | SEARCH | SEARCH | SEARCH |
| Semantic and Contextual | | X | X |
| Modelling | | | |
| Question Answering | | X | X |
| Language Interoperability | | X | X |
| Generalization to New Words | X | | X |
| Cold Start Problem | | X | X |
| Real-time Performance | X | | X |
| Alpha-Numeric and | X | | X |
| One-Word Queries | | | |

Semantic and Contextual Modelling: The hybrid solution leverages the strengths of the embedding similarity search method to comprehend context and semantics, which is an aspect that keyword similarity search lacks.

Question Answering: The hybrid approach effectively handles question type queries by combining understanding from embedding similarity search with the lookup capabilities of keyword similarity search to find targeted answers to the posted question.

Language Interoperability: The hybrid model inherits the language agnostic nature of embedding similarity search. This allows the hybrid search to cater to users regardless of their language.

Generalization to New Words: Unlike embedding similarity search, which may require retraining to generalize to new words, the hybrid solution utilizes the generalization capabilities of keyword similarity search to circumvent this limitation.

Cold Start Problem: By utilizing the embedding similarity search method, the hybrid solution is able to overcome the cold start problem.

Real-time Performance: By utilizing a reverse index database with optimal number of shards and nodes, the hybrid solution is able to achieve real time retrieval latencies.

Alpha-Numeric and One-Word Queries: By utilizing keyword similarity search, the hybrid solution is able to satisfy this design criteria.

By fulfilling the design criteria with the hybrid solution, the information retrieval system disclosed herein delivers a comprehensive solution that meets a wide range of search and retrieval needs for an enterprise-specific use cases.

An advantage of the hybrid search solution is its ability to combine keyword-based searching with a more modern, sentence-embeddings-based search techniques. This unique approach offers advantages that cater to both algorithmic and engineering design criteria. Moreover, this solution fulfills desired design criteria without necessitating retraining thereby providing a low-maintenance, high-performance information retrieval system.

The hybrid search algorithm features a scoring function designed to serve various specific use cases. Unlike off-the-shelf algorithms that offer a one-size-fits-all approach, the hybrid scoring function caters to the nuanced demands of an enterprise's data. By combining keyword match scores and embedding (semantic) similarity scores in a balanced formula, the hybrid algorithm significantly improves the search results' relevance and accuracy. This contributes to a more effective and accurate predictions which are uniquely tailored to the entity's use cases and data.

One of the most noteworthy advantages of the hybrid solution is that it eliminates the need for continual retraining. Traditional machine learning-based search systems require frequent retraining to generalize to new data. Retraining or fine-tuning large transformer models requires significant time, compute, and expertise, which severely restricts maintainability of solutions that solely dependent on traditional machine learning-based search systems. The hybrid algorithm is designed to generalize to new and varied types of input without the need for constant updates, while achieving accuracies similar to retrained or finetuned transformer models. This results in reduced operational overhead and ensures that the information retrieval system remains agile and adaptable over time, thereby proving to be cost-efficient.

To make the hybrid solution even more effective, two layers of entity-specific optimizations are incorporated into the system.

First, a Line of Business (LOB) weight is incorporated to further improve relevance of the returned results based on a LOB parameter received during the querying process. For example, if the entity is a computer company, then the LOB parameter may be associated with a particular computer model, such as a laptop, desktop, server, etc. If the entity is a vehicle manufacturer, then the LOB may be a particular model or type of vehicle. A particular entity can adapt the hybrid solution to incorporate any appropriate LOB weight.

Second, a custom analyzer is implemented to isolate entity-specific information, such as product codes, error codes, model numbers, etc. This ensures that alphanumeric labels with special characters are not inadvertently separated, parsed, or removed during preprocessing and that this entity-specific information is accurately represented in preprocessed data, database indices, and retrieved information.

By integrating entity-specific data such as Lines of Business, product categories, error codes, and other internal metrics into the scoring process, the hybrid algorithm is able to generalize and operate effectively on queries and data containing these specific terms.

One of the measures for evaluating search algorithm success is top-n accuracy, which represents the percentage of queries that get at least one relevant answer in the top-n returned values. Observations of results using the hybrid search achieved a top-1 accuracy rate of 67% with a top-3 accuracy rate of 71%. The accuracy of the untrained hybrid search model is similar to fine-tuned BERT, BART, and ColBERT retrieval models. These accuracy levels may be attained without any retraining, which highlights the resilience and adaptability of the hybrid search algorithm. This is an advantage as it reduces the maintenance workload and ensures long term sustainability of the system.

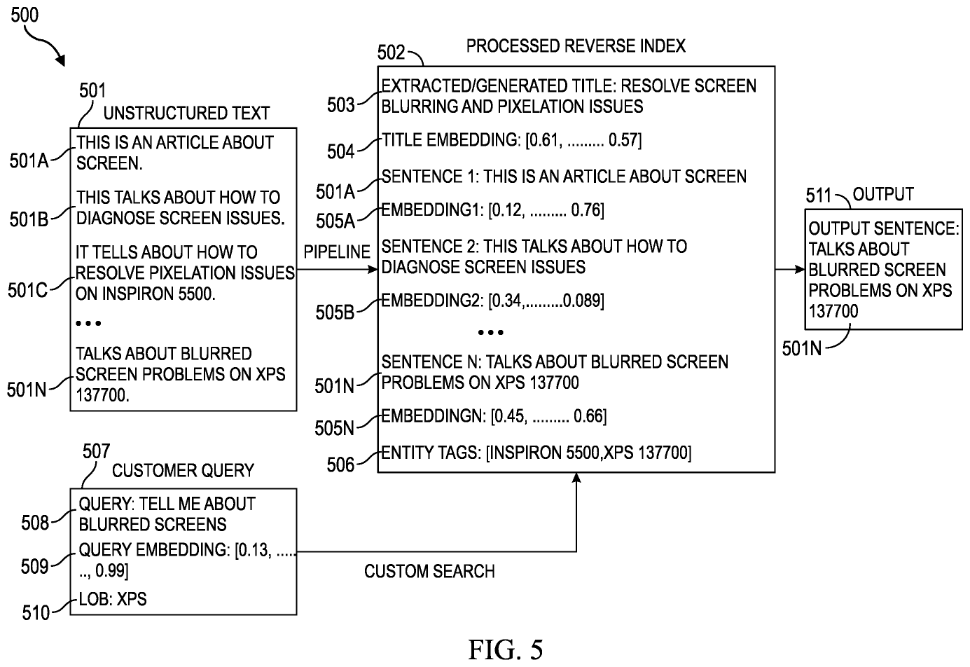

FIG. 5 is a flowchart 500 illustrating how the hybrid search algorithm works for an entity's information retrieval system. The entity may be, for example, a multinational technology company with a wide variety of products including personal computers, servers, monitors, computer software, computer security, and network security that supports customers in managing their IT infrastructure and in operating anywhere from standalone machines to a multi-cloud environment. Such an entity would have a vast knowledge base of technical support documentation that forms the data set for information retrieval for various use cases.

The knowledge base includes numerous text documents from which unstructured text 501 can be extracted. The unstructured text 501 comprises a plurality of sentences 501a-n that can be broken down and analyzed individually to create a reverse index 502. The reverse index 502 comprises an embedding for a title 503 of the unstructured text 501 and for each sentence 501a-n of the unstructured text 501. The title 503 may be extracted from the unstructured text or from metadata associated with the unstructured text 501 or may be generated from the contents of the sentences 501a-n. A title embedding 504 is generated for the title 503. Additional embeddings 505a-n are generated for each sentence 502a-n of the unstructured text 501. During processing of the unstructured text 501, entity-specific tags 506 are extracted. These entity-specific tags 506 include, for example, product codes, brand names, error codes, model names or numbers, and other words or alphanumeric labels which may have special characters that are associated with products or services offered by the entity.

Once the reverse index 502 has been generated for documents in the entity's knowledge base, then user queries 507 may be run against the index 502. For example, a customer may enter query text 508 secking information about a particular problem, product, or feature. The information retrieval system generates an embedding 509 for the query text 508. Additional information, such as line of business (LOB) information 510, may also be collected directly or indirectly from the user.

The customer query 507 is applied against the reverse index 502 for all of the entity's knowledge base documents and a score is generated for each sentence 501a-n in each text document 501. The score may be generated using the hybrid scoring equation (2) shown above. Alternatively, the search scoring method may be customized for a particular entity's information retrieval system based on the type of information the is included in the knowledge base and the type of information collected from users.

For example, a customer search score may be calculated as:

$$search score = ( 1 + {k}_{1} ) * ( 1 + {k}_{2} ) * ( 1 + {k}_{3} ) * ( 1 + {s}_{1} ) * ( 1 + {s}_{2} ) \qquad ( Eq . 5 )$$

where:
k₁ represents the score for the first keyword matching between the query 508 and the document title 503,
k₂ represents the score for the second keyword matching between the query 508 and the document sentences 501a-n,
k₃ represents the score for the third keyword matching between the LOB 510 and the entity tags 506,
s₁ denotes the first search score based on embeddings, which measures cosine similarity between query embeddings 509 and title embeddings 504, and
s₂ denotes the second search score based on embeddings, which measures cosine similarity between query embeddings 509 and sentence embeddings 505a-n.

Each sentence of each document in the knowledge base is scored using the search score equation (5) and scores are ranked. The sentence with the top score is then output 511 to the user. In the illustrated example, sentence 501n in the unstructured text 501 has the highest score and so that sentence is displayed to the user. This scoring method allows the information retrieval system to identify the best single sentence from the entire knowledge base and to present specific relevant information to the user.

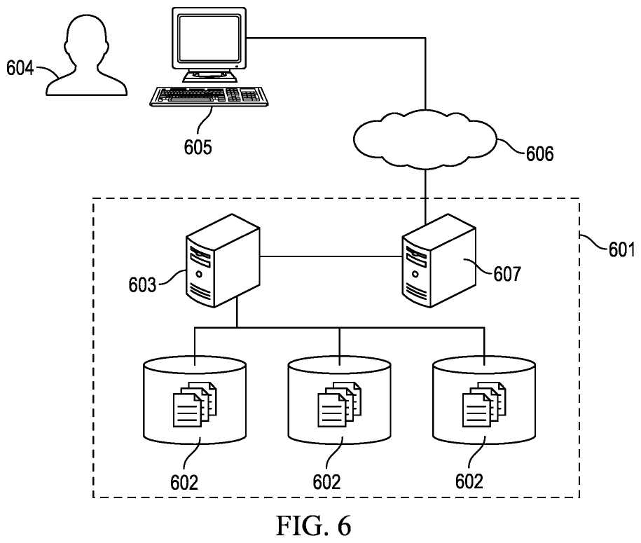

FIG. 6 is a high level block diagram illustrating components for implementing an information retrieval system and for performing the actions in flowchart 500 (FIG. 5). An entity 601, such as a business, has a knowledge base comprising numerous text documents including, for example, technical support documentation, service manuals, user manuals, troubleshooting guidelines, etc., such as text document 501. These text documents may be stored in various databases 602 and other storage within the entity 601. When documents are added to these databases 602, they are also added to a distributed inverted index database 603 that stores keywords and embeddings for the sentences within the documents that form the knowledge base, such as reverse index 502.

A user 604 may interact with the entity 601 via a remote terminal 605, such as a laptop or tablet, connected to the Internet 606. User 604 on terminal 605 can access an entity webserver 607 via Internet 606. Webserver 607 may host a support website that provides a virtual assistant or chatbot, for example, to interact with user 604. The support website allows the user 604 to enter a query, such as query 508. The support website may then generate a query embedding, such as embedding 509. The embeddings may be created by any present or future Large Language Model (LLM) or encoder. The keyword lexical search algorithm can also be replaced with a contemporary or future alternative.

The support website may also collect line of business (LOB) information 510. The LOB information may be provided by the user 604 or may be auto detected, such as by a query from webserver 607 to terminal 605. For example, the webserver may be able to autodetect a model type for terminal 605 and may then include that model type in the customer query 507.

Once webserver has received the query information 507, it may provide the query to an information retrieval application that applies a custom hybrid search function, such as equation (5) above, by comparing the query 507 to the reverse index 502 to generate scores for each of the sentences in the knowledge base. The information retrieval application may then rank the custom hybrid scores to identify the top match between the query 507 and one sentence 501a-n in the knowledge base. That top-matching sentence 501a-n is then presented to the user 604 on the display of terminal 605. In other embodiments, the information retrieval system may return the top N matching sentences from the knowledge base where N is selected by the entity or the user. The hybrid search solution recommends knowledge base articles with targeted answers that are highlighted for the user to encourage entity customers to self-resolve their issues.

While the illustrated example of FIG. 6 shows the entity components grouped together, it will be understood that the knowledge base documents and databases 602 may be located in anywhere worldwide and may include any number documents. Also, the distributed inverted index database 603 may be located remote from all of the databases 602 and/or may share a server with one or more database 602. Webserver 607 and an information retrieval application may be hosted by the entity 601 or, in some embodiments, may be hosted by a third party.

The inverted index database 603 is populated using custom data processing and indexing for entity-specific use cases. The index uses the entity's understanding of its own data to extract entity-specific tags related to product codes, LOBs, error codes, etc. These tags are used in the hybrid search method to improve the relevance of results for entity-specific queries. Unstructured data in the entity knowledge base is processed to create titles if none is available, which ensures that each chunk of data is indexed homogenously in the index structure.

The custom search-scoring function (i.e., equation (2) or (5) may be finetuned to provide highly relevant results by utilizing the custom index. The scoring function and the custom index enabled the information retrieval application to outperform existing information retrieval solutions.

The extraction of product codes and LOB from unstructured data allows the entity to use an auto-detect feature in the entity's support channels, such as a virtual assistant, support assist, or chatbot help. The auto-detect feature provides metadata about the LOB of the device being used by the customer to access support, which helps to further improve the relevance of the returned results.

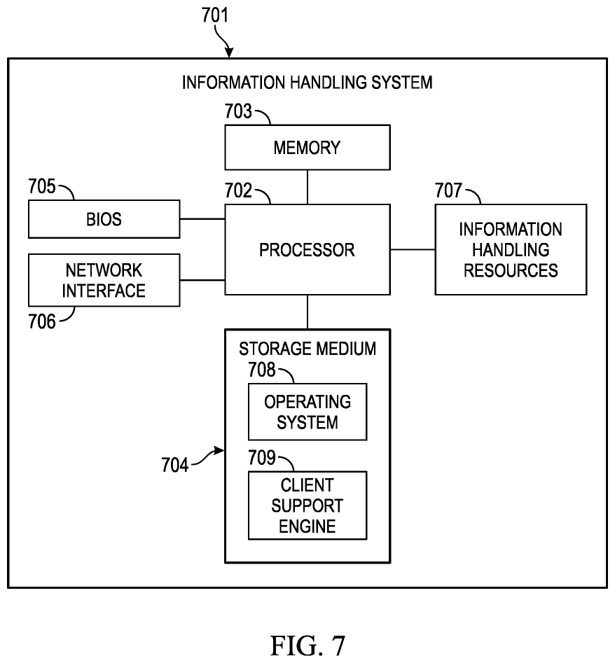

FIG. 7 illustrates a block diagram of an example information handling system 701 for executing operations associated with an information retrieval system in accordance with embodiments of the present disclosure. In some embodiments, information handling system 701 may comprise a server. In other embodiments, information handling system 701 may be a personal computer (e.g., a desktop computer, a laptop, notebook, tablet, handheld, smart phone, personal digital assistant, etc.). As depicted in FIG. 7, information handling system 701 may include a processor 702, a memory 703 communicatively coupled to processor 702, a storage medium 704 communicatively coupled to processor 702, a basic input/output system (BIOS) 705 communicatively coupled to processor 702, a network interface 706 communicatively coupled to processor 702, and one or more other information handling resources 707 communicatively coupled to processor 702.

Processor 702 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 702 may interpret and/or execute program instructions and/or process data stored in memory 703, storage medium 704, BIOS 705, and/or another component of information handling system 701.

Memory 703 may be communicatively coupled to processor 702 and may include any system, device, or apparatus configured to retain program instructions and/or data for a period of time (e.g., computer-readable media). Memory 703 may include RAM, EEPROM, a PCMCIA card, flash memory, magnetic storage, opto-magnetic storage, or any suitable selection and/or array of volatile or non-volatile memory that retains data after power to information handling system 701 is turned off.

Storage medium 704 may be communicatively coupled to processor 702 and may include any system, device, or apparatus operable to store information processed by processor 702. Storage medium 704 may include, for example, network attached storage, one or more direct access storage devices (e.g., hard disk drives), and/or one or more sequential access storage devices (e.g., tape drives). As shown in FIG. 7 an operating system (OS) 708, and a client support engine 709 may be stored on storage medium 704.

OS 708 may be any program of executable instructions, or aggregation of programs of executable instructions, configured to manage and/or control the allocation and usage of hardware resources such as memory, CPU time, disk space, and input and output devices, and provide an interface between such hardware resources and application programs hosted by OS 708. Active portions of OS 708 may be transferred to memory 703 for execution by processor 702.

Client support engine 709 may comprise a program of instructions configured to, when loaded into memory 703 and executed by processor 702, perform one or more tasks related to collection and communication (e.g., via network interface 706) of telemetry information associated with information handling resources of information handling system 701 (including, without limitation, storage medium 704 and information handling resources 707), as is described in greater detail elsewhere in this disclosure.

BIOS 705 may be communicatively coupled to processor 702 and may include any system, device, or apparatus configured to identify, test, and/or initialize information handling resources of information handling system 701. “BIOS” may broadly refer to any system, device, or apparatus configured to perform such functionality, including without limitation, a Unified Extensible Firmware Interface (UEFI). In some embodiments, BIOS 705 may be implemented as a program of instructions that may be read by and executed on processor 702 to carry out the functionality of BIOS 705. In these and other embodiments, BIOS 705 may comprise boot firmware configured to be the first code executed by processor 702 when information handling system 701 is booted and/or powered on. As part of its initialization functionality, code for BIOS 705 may be configured to set components of information handling system 701 into a known state, so that one or more applications (e.g., operating system 708 or other application programs) stored on compatible media (e.g., memory 703, storage medium 704) may be executed by processor 702 and given control of information handling system 701.

Network interface 706 may include any suitable system, apparatus, or device operable to serve as an interface between information handling system 701 and a network external to information handling system 701 (e.g., Internet 606 depicted in FIG. 6). Network interface 706 may allow information handling system 701 to communicate via an external network using any suitable transmission protocol and/or standard.

Generally speaking, information handling resources 707 may include any component system, device or apparatus of information handling system 701, including without limitation processors, buses, computer-readable media, input-output devices and/or interfaces, storage resources, network interfaces, motherboards, electro-mechanical devices (e.g., fans), displays, batteries, and/or power supplies.

In an example embodiment, a computer-implemented method of performing a search in a document database comprises automatically detecting a line of business associated with a user, receiving a text query from the user, and generating a query embedding from the text query. The method further includes scoring entries in a reverse index using a hybrid scoring function. The reverse index comprises titles, title embeddings, sentences, sentence embeddings, and entity tags corresponding to documents in the document database. The hybrid scoring function is used to generate a score based both on a keyword match score (which is a score based on the text query and sentence text in the reverse index) and on a cosine similarity score (which is calculated from embeddings in the text query and in the reverse index). The method further includes ranking scores for sentences in the document database and displaying the sentence associated with a top hybrid score to the user.

The hybrid scoring function has the general form:

$$Hybrid Score = ( 1 + Keyword Match Score ) \times ( 1 + Cosine Similarity Score ) \qquad ( Eq . 1 )$$

The hybrid scoring function can be modified to include multiple keyword match and cosine similarity sub-scores using the form:

$$Hybrid Score = ( 1 + k 1 ) \times ( 1 + k 2 ) \times ( 1 + k 3 ) \times ( 1 + s 1 ) \times ( 1 + s 2 ) \qquad ( Eq . 2 )$$

wherein
k1 represents a score for a first keyword match sub-score between the text query and the titles in the reverse index;
k2 represents a score for a second keyword match sub-score between the text query and the sentences in the reverse index;
k3 represents a score for a third keyword match sub-score between the user line of business and the entity tags in the reverse index;
s1 denotes a first search score based on embeddings, which measures cosine similarity between the query embedding and the title embeddings in the reverse index; and
s2 denotes a second search score based on embeddings, which measures cosine similarity between the query embedding and the sentence embeddings in the reverse index.

The user line of business may be detected based upon a device used by the user to send the text query. For example, the model number, serial number, brand name, or other information may be automatically captured from the device that the user used to access an information retrieval system (e.g., the type of laptop that accessed a web-based virtual assistant). That device can be associated with a particular line of business for the entity, such as a particular entity product line (e.g., XPS, Inspiron), device type (e.g., smartphone, tablet, laptop, desktop, server), corporate department or division, sales channel, vendor, or the like.

The user line of business may alternatively be determined based on a product or device associated with a user account. For example, if the user's device cannot be automatically identified but the user has identified themselves or a user account, then information associated with the user account may be used to determine or estimate a relevant line of business.

The line of business and the entity tags may include product codes or names, product categories, product types, product line, error codes, device type, model numbers, serial numbers, entity brand names, corporate department or division, sales channel, vendor, etc.

The reverse index may be divided into shards as shown in FIG. 4 and the method may include storing groups of the shards at two or more locations and scoring entries in multiple reverse index shards simultaneously. This allows for faster searching and scoring using parallel processing of the query.

The method may further comprise creating replicas of the shards and storing groups of the replicas at the two or more locations. This provides a backup for the reverse index in the event some shards of the reverse index are damaged or unavailable.

When the sentence associated with a top hybrid score is displayed to the user, other information may also be provided such as a link to a source document for the sentence associated with the top score. For example, the text of the single sentence best-matching the user's query may be shown to the user along with optional links to see the source document for that sentence to provide greater context to the user. In other embodiments, the top N best-matching sentences may be displayed in response to the user's query (e.g., the three best matching sentences may be shown). The value of N may be selectable based on a default or predetermined value (i.e., always show N sentences) or may be selected based on the numerical distribution of the ranked scores (i.e., show any sentences with a score within a certain range of the top score such as within 0.01 or within 0.1% of the top score).

In other embodiments, a processing system for performing an information retrieval search in an entity document database comprises at least one processor device comprising: a user-interface component, an indexing component, a query generation component, a search component, and a display component. The processing system further includes at least one computer-readable memory devices configured to store entity documents and the index.

The user-interface component is configured to receive query text from a user and to automatically detect entity line of business information for the user.

The indexing component is configured to generate an index of documents stored in the entity document database. The index comprises, for example, titles, title embeddings, sentences, sentence embeddings, and entity tags corresponding to the documents. In other embodiments, the index may include other fields such as comment fields and comment embeddings instead of title and title embeddings where the comment fields are associated with user comments about the documents in the database.

The query generation component is configured to identify keywords in the query text and to create a query embedding from the query text.

The search component is configured to score entries in the index using a hybrid scoring function. The hybrid scoring function is used to generate a score based both on a keyword match score between the query text and text in the index and on a cosine similarity score that is calculated from the query embedding and embeddings in the index. The search component may be further configured to rank the scores for sentences in the entity document database or an additional ranking component may be used to rank the scores.

The display component is configured to cause a sentence associated with a top score to be displayed to the user.

These components may each run on different processor devices. Alternatively, some or all of the components may run on the same processor device. For example, the user-interface component and the display component may be executing on a processor on a webserver, the indexing component may be executing on a processor on a document management server, and the query generation and search components may be executing on a processor on an information retrieval server.

The hybrid scoring function and/or a modified hybrid scoring function used by the processing system may have one of the forms discussed above, such as shown in equations (1) or (2).

The entity line of business may be detected based upon a device used by the user to send the query text or based on a product or device associated with a user account.

The processing system may include a plurality of the computer-readable memory devices, and shards of the index may be stored across different ones of the memory devices. The processing system search component may be configured to score entries in separate index shards simultaneously. The processing system may store replicas of the index shards across different ones of the memory devices.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

1. A computer-implemented method of performing a search in a document database, comprising:
automatically detecting a line of business associated with a user;
receiving a text query from the user;
generating a query embedding from the text query;
scoring entries in a reverse index using a hybrid scoring function, wherein the reverse index comprises titles, title embeddings, sentences, sentence embeddings, and entity tags corresponding to documents in the document database, and wherein the hybrid scoring function is used to generate scores, each generated score based both on a keyword match score between the text query and the reverse index and on a cosine similarity score calculated from embeddings in the text query and in the reverse index;
ranking the generated scores for sentences in the document database; and
displaying a sentence associated with a top score, from among the ranked scores, to the user.

2. The method of claim 1, wherein the hybrid scoring function has the form:
$$Hybrid Score = ( 1 + Keyword Match Score ) \times ( 1 + Cosine Similarity Score ) .$$

3. The method of claim 1, wherein the hybrid scoring function has the form:
$$Hybrid Score = ( 1 + k 1 ) \times ( 1 + k 2 ) \times ( 1 + k 3 ) \times ( 1 + s 1 ) \times ( 1 + s 2 ) ,$$
and
wherein
k1 represents a score for a first keyword matching between the text query and the titles;
k2 represents a score for a second keyword matching between the text query and the sentences;
k3 represents a score for a third keyword matching between the user line of business and the entity tags;
s1 denotes a first search score based on embeddings, which measures cosine similarity between the query embedding and the title embeddings; and
s2 denotes a second search score based on embeddings, which measures cosine similarity between the query embedding and the sentence embeddings.

4. The method of claim 1, wherein the user line of business is detected based upon a device used by the user to send the text query.

5. The method of claim 1, wherein the user line of business is determined based on a product or device associated with a user account.

6. The method of claim 1, wherein the line of business and the entity tags comprise one or more of:
product codes or names, product categories, product types, error codes, lines of business, model numbers, serial numbers, and entity brand names.

7. The method of claim 1, further comprising:
dividing the reverse index into shards;
storing groups of the shards at two or more locations; and
scoring entries in multiple reverse index shards simultaneously.

8. The method of claim 7, further comprising:
creating replicas of the shards; and
storing groups of the replicas at the two or more locations.

9. The method of claim 1, further comprising:
providing the user with a link to a source document for the sentence associated with the top score.

10. A processing system for performing an information retrieval search in an entity document database, comprising:
at least one processor device comprising:
a user-interface component configured to receive query text from a user and to automatically detect entity line of business information for the user;
an indexing component configured to generate an index of documents stored in the entity document database, wherein the index comprises titles, title embeddings, sentences, sentence embeddings, and entity tags corresponding to the documents;
a query generation component configured to identify keywords in the query text and to create a query embedding from the query text;
a search component configured to score entries in the index using a hybrid scoring function, wherein the hybrid scoring function is used to generate scores, each generated score based both on a keyword match score between the query text and the index and on a cosine similarity score calculated from the query embedding and embeddings in the index, the search component further configured to rank the generated scores for sentences in the entity document database; and
a display component configured to cause a sentence associated with a top score, from among the ranked scores, to be displayed to the user; and
at least one computer-readable memory device configured to store entity documents and the index.

11. The processing system of claim 10, wherein the hybrid scoring function has the form:
$$Hybrid Score = ( 1 + Keyword Match Score ) \times ( 1 + Cosine Similarity Score ) .$$

12. The processing system of claim 10, wherein the hybrid scoring function has the form:
$$Hybrid Score = ( 1 + k 1 ) \times ( 1 + k 2 ) \times ( 1 + k 3 ) \times ( 1 + s 1 ) \times ( 1 + s 2 ) ,$$
and
wherein
k1 represents a score for a first keyword matching between the query text and the titles;
k2 represents a score for a second keyword matching between the query text and the sentences;
k3 represents a score for a third keyword matching between the entity line of business and the entity tags;
s1 denotes a first search score based on embeddings, which measures cosine similarity between the query embedding and the title embeddings; and
s2 denotes a second search score based on embeddings, which measures cosine similarity between the query embedding and the sentence embeddings.

13. The processing system of claim 10, wherein the entity line of business is detected based upon a device used by the user to send the query text.

14. The processing system of claim 10, wherein the entity line of business is determined based on a product or device associated with a user account.

15. The processing system of claim 10, wherein the entity line of business and the entity tags comprise one or more of:
product codes or names, product categories, product types, error codes, lines of business, model numbers, serial numbers, and entity brand names.

16. The processing system of claim 10, further comprising:
a plurality of the computer-readable memory devices, wherein shards of the index are stored across different ones of the memory devices.

17. The processing system of claim 16, wherein the search component is further configured to score entries in separate index shards simultaneously.

18. The processing system of claim 16, further comprising:
replicas of the index shards are stored across different ones of the memory devices.

19. The processing system of claim 10, wherein the display component is further configured to provide the user with a link to a source document for the sentence associated with the top score.
